(19) United States
(12) Patent Application Publication
(10) Pub. No.: US 2015/0362913 A1
(43) Pub. Date: Dec. 17, 2015

(54) PRINTING METHOD AND STORAGE DEVICE FOR 3D PRINTER

(71) Applicants: Inventec Appliances (Shanghai) Corporation, Shanghai (CN); Inventec Appliances (Shanghai) Co., Ltd., SHANGHAI (CN); Inventec Appliances Corp., New Taipei City (TW)

(72) Inventors: Ying LIU, SHANGHAI CITY (CN); Li YU, SHANGHAI CITY (CN); Shih-Kuang TSAI, SHANGHAI CITY (CN)

(21) Appl. No.: 14/543,901

(22) Filed: Nov. 18, 2014

(30) Foreign Application Priority Data
Jun. 13, 2014 (CN) 201410263623.8

(51) Int. Cl. G05B 19/4099

(52) U.S. Cl. CPC G05B 19/4099; G05B 2219/49023

(57) ABSTRACT

A printing method and a storage device for a 3D printer are provided. Model data information and corresponding printing parameter information is configured simultaneously with respect to the 3D printer. When the 3D printer prints the 3D printed object, the model data information of the 3D printed object and the corresponding printing parameter information are obtained. The corresponding printing parameter information is adopted. A process for printing the 3D printed object is performed according to the model data information of the 3D printed object. The invention can improve a 3D printing quality of the 3D printed object.

### RELATED APPLICATIONS

This application claims priority to Chinese Application Serial Number 201410263623.8, filed on Jun. 13, 2014, which is herein incorporated by reference.

### BACKGROUND

1. Field of Invention

The present invention relates to a field of a 3-dimensional (3D) printer. More particularly, the present invention relates to a printing method, and a storage device for the 3D printer.

2. Description of Related Art

3D printing is a form of an additive manufacturing technology. In the additive manufacturing technology, a 3D printed object is created out of successive physical layers by a 3D printer. Compared to other additive manufacturing technologies, the 3D printer is advantageously fast, cheap and high easy of use. The 3D printer is a device that can print a real 3D object and functions as laser forming technology, which generates the 3D printed object by hierarchical processing and superimposed layers forming, by increasing material layer by layer to generate the 3D printed object), and is completely different from a conventional material removal process technology. The so-called 3D printer references the technical principle of printer, because the procedure of the layer processing is very similar to the working principle of the Inkjet printer.

Currently, when the 3D printer prints the 3D printed object, model data information of the 3D printed object is first obtained. Then, a process for printing the 3D printed object is performed according to the model data information of the 3D printed object and by adopting the preset universal printing parameter information. Thereafter, the 30 printed object is obtained.

A 3D printing procedure of the 3D printer is complicated and generally involves hundreds of pieces of printing parameter information such as a printing flow and a printing temperature. In order to easily perform the 3D printing procedure of the 3D printer for a user, a manufacturer of the 3D printer sets universal printing parameter information in advance and store it into the 3D printer. The preset universal printing parameter information is default printing parameter information. When the 3D printed object is printed, the universal printing parameter information is directly used to perform the 3D printing to ensure the 3D printing quality of most of the 3D printed objects.

Although adopting this kind of approach to perform the 3D printing can ensure the 3D printing quality of most of the 3D printed objects, the quality of the 3D printing will be decreased if the preset universal printing parameter is adopted when performing the 3D printing for the 3D printed object which has a special model structure (because the 3D printed object is varied).

### SUMMARY

An embodiment of the invention provides a printing method for a 3D printer, and the printing method is capable of improving the 3D printing quality of the 3D printed object.

An embodiment of the invention also provides a storage device of the 3D printer, and the storage device is capable of improving the 3D printing quality of the 3D printed object.

To achieve the aforementioned object, the invention provides a printing method for the 3D printer and the printing method includes the following steps. Model data information and printing parameter information corresponding to a 3D printed object are configured. When the 3D printer prints the 3D printed object, the model data information and the printing parameter information corresponding to the 3D printed object are obtained. The corresponding printing parameter information is adopted, and a process for printing the 3D printed object is performed according to the model data information.

The printing parameter information is specific printing parameter information with respect to a feature of the 3D printed object. The step of adopting the corresponding printing parameter information and performing a process for printing the 3D printed object according to the model data information of the 3D printed object includes the following steps. Universal printing parameter information configured in the 3D printer is obtained. The specific printing parameter information regarding the feature of the 3D printed object is adopted. The universal printing parameter information is excluded except the specific printing parameter information regarding the feature of the 3D printed object. The process for printing the 3D printed object is performed according to the model data information of the 3D printed object.

The printing parameter information includes the specific printing parameter information regarding the feature of the 3D printed object, and the universal printing parameter information of the 3D printer.

Before the model data information and the printing parameter information corresponding to the 3D printed object are obtained, the printing method includes the following steps. The model data information and the printing parameter information corresponding to the 3D printed object are included into a 3D model document, and the 3D model document is outputted. The step of obtaining the printing parameter information corresponding to the 3D printed object includes the following steps. A 3D printing procedure is configured to import the 3D model document. The universal printing parameter information configured in the 3D printer is replaced with the printing parameter information in the 3D model document to constitute complete printing parameter information with universal printing parameter information configured in another printer. An universal format is adopted to output the complete printing parameter information.

Before the model data information and the printing parameter information corresponding to the 3D printed object are obtained, the printing method includes the following steps. The model data information and the printing parameter information corresponding to the 3D printed object are included into a 3D model document and the 3D model document is outputted. The step of obtaining the printing parameter information corresponding to the 3D printed object includes the following steps. A 3D printing procedure is configured to import the 3D model document. The printing parameter information in the 3D model document is added into an end of universal printing parameter information configured in the 3D printer. A universal format is adopted to output the universal printing parameter information.

The step of adopting the corresponding printing parameter information, and performing the process for the printing the 3D printed object according to the model data information of the 3D printed object includes the following steps. The complete printing parameter information and the model data information in the 3D model document is encoded by the 3D printing procedure to generate a graphical coding (Gcode) document. The 3D printer analyzes the graphical coding document, and uses the graphical coding document to perform the process for printing the 3D printed object.

A storage device of the 3D printer is provided. The storage device includes a configuring unit, an outputting unit and an integrating unit. The configuring unit is adapted to configure model data information and printing parameter information corresponding to a 3D printed object. The outputting unit is adapted to output the model data information and the printing parameter information. The integrating unit is adapted to encode the model data information and the printing parameter information obtained from the outputting unit to generate a graphical coding document.

The outputting unit is further adapted to include the model data information and the printing parameter information into a 3D model document, and to output the 3D model document. The integrating unit is further adapted to perform a encoding procedure to generate the graphical coding document after replacing universal printing parameter information configured in the 3D printer with the printing parameter information obtained from the 3D model document to constitute complete printing parameter information with universal printing parameter information configured in another printer, or after adding the printing parameter information obtained from the 3D model document into an end of the universal printing parameter information configured in the 3D printer.

The printing parameter information is specific printing parameter information regarding a feature of the 3D printed object. The integrating unit is further adapted to obtain universal printing parameter information configured in the 3D printer, adopt the specific printing parameter information corresponding to the feature of the 3D printed object, and exclude universal printing parameter information except the specific printing parameter information corresponding to the feature of the 3D printed object, and perform an encoding procedure to generate the graphical coding document.

The printing parameter information includes specific printing parameter information regarding a feature of the 3D printed object, and universal printing parameter information of the 3D printer.

It can be seen from the descriptions that the model data information and the corresponding printing parameter information is configured at the same time for the 3D printed object in the embodiments of the invention. When the 3D printer prints the 3D printed object, the model data information of the 3D printed object and the corresponding printing parameter information are obtained, the corresponding printing parameter information is adopted, and the process for printing the 3D printed object is performed according to the model data information of the 3D printed object. Since the printing parameter information configured in the invention is with respect to different models of the 3D printed object, configurations are different and are only applied to the corresponding 3D printed object, thus the 3D printed object is highly targeted. Therefore, the method and the storage device provided in the embodiments of the invention can improve the 3D printing quality of the 3D printed object.

### BRIEF DESCRIPTION OF THE DRAWINGS

The invention can be more fully understood by reading the following detailed description of the embodiment, with reference made to the accompanying drawings as follows:

FIG. 1 is a flow chart of a printing method for a 3D printer according to an embodiment of the invention;

FIG. 2 is a schematic diagram illustrating a process of importing a 3D model document into a printing procedure according to an embodiment of the invention;

FIG. 3 is a flow chart of a printing method for the 3D printer according to an embodiment of the invention;

FIG. 4 is a diagram illustrating a structure of a cube to be printed according to an embodiment of the invention;

FIG. 5 is a diagram illustrating a structure of a printed cube according to an embodiment of the invention;

FIG. 6 is a diagram illustrating a structure of a printed cube according to a technology in a prior art; and

FIG. 7 is a schematic diagram illustrating a storage device of the 3D printer according to an embodiment of the invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

In an embodiment of the invention, when a 3D printer performs a 3D printing, not only model data information is configured for a 3D printed object, but also corresponding printing parameter information is configured in order to improve a 3D printing quality of the 3D printed object. When the 3D printer prints the 3D printed object, the model data information of the 3D printed object and the corresponding printing parameter information is obtained, and the corresponding printing parameter information is adopted, and a process for printing the 3D printed object is performed according to the model data information of the 3D printed object. Since the configured printing parameter information is regarding to different models of the 3D printed object, configurations are different and are only applied to the corresponding 3D printed object, thus the 3D printed object is highly targeted and insufficiency of adopting preset universal printing parameter information can be compensated to improve the 3D printing quality of the 3D printed object.

In an embodiment of the invention, the model data information of the 3D printed object and the corresponding printing parameter information are included in printing software of the 3D printed object. When the 3D printer prints the 3D printed object, the printing software is imported to replace the corresponding preset universal printing parameter information to perform the 3D printing.

In an embodiment of the invention, the model data information of the 3D printed object is reserved without changes in the printing software of the 3D printed object, and thus high consistency is maintained. The corresponding printing parameter information is configured following the part of he model data information of the 3D printed object in the printing software of the 3D printed object, and a format such as an eXtensible Markup Language (XML) can be adopted to provide a good compatibility.

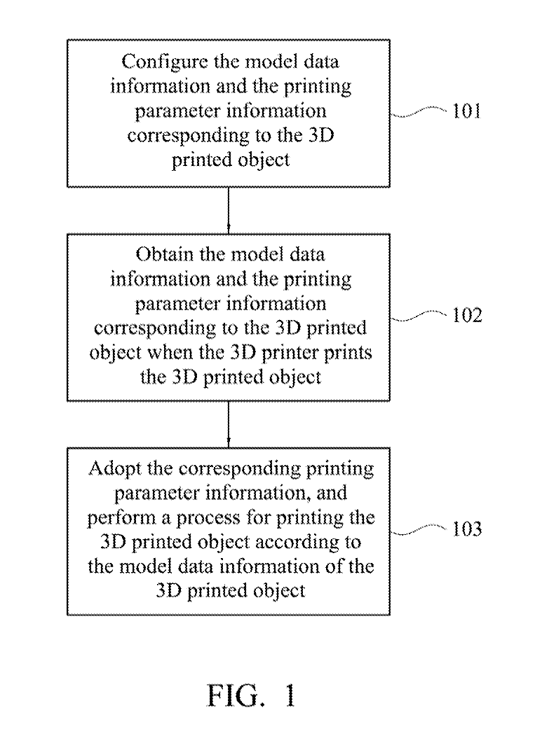

FIG. 1 is a flow chart of a printing method for the 3D printer according to an embodiment of the invention and includes the following steps. In a step 101, the model data information and the printing parameter information corresponding to the 3D printed object are configured. In a step 102, the model data information and the printing parameter information corresponding to the 3D printed object are obtained when the 3D printer prints the 3D printed object. In a step 103 the corresponding printing parameter information is adopted, and a process for printing the 3D printed object is performed according to the model data information of the 3D printed object.

In an embodiment of the invention, the configured printing parameter information corresponding to the 3D printed object can be a portion of printing parameter information required in the 3D printing. That is, the configured printing parameter information may be some specific printing parameters configured for a structure uniqueness of a feature of the 3D printed object. Universal printing parameter information configured in the 3D printer is replaced by the specific printing parameter information, and the other part of the printing parameter information required by the 3D printing still can adopt the universal printing parameter information configured in the 3D printer. A universal format such as XML can be adopted to output the printing parameter information. Alternatively, the printing parameter information with respect to the feature of the 3D printed object can be added into an end of the universal printing parameter information configured in the 3D printer, and the universal format is adopted to output the universal printing parameter information.

In an embodiment of the invention, the printing parameter information configured in the 3D printed object may also include the specific printing parameter information with respect to the feature of the 3D printed object and the universal printing parameter information of the 3D printer.

In an embodiment of the invention, when the printing parameter information is the specific printing parameter information with respect to the feature of the 3D printed object, the step of adopting the corresponding printing parameter information and performing the process for printing the 3D printed object according to the model data information of the 3D printed object includes the following steps. The universal printing parameter information configured in the 3D printer is obtained. The specific printing parameter information regarding the feature of the 3D printed object is adopted. The universal printing parameter information is excluded except the specific printing parameter information regarding the feature of the 3D printed object. The process for printing the 3D printed object is performed according to the model data information of the 3D printed object.

In an embodiment of the invention, the model data information and the printing parameter information corresponding to the 3D printed object are configured in a 3D model document. When the 3D printer prints, the 3D model document is imported into a printing procedure. That is, the printing parameter information corresponding to the 30 printed object is imported into the printing procedure and is encoded, and the model data information is also encoded to generate a graphical coding (Gcode) document. In the following 3D printing, the 3D printer analyzes the graphical coding document according to the technology in the prior art to perform the 3D printing.

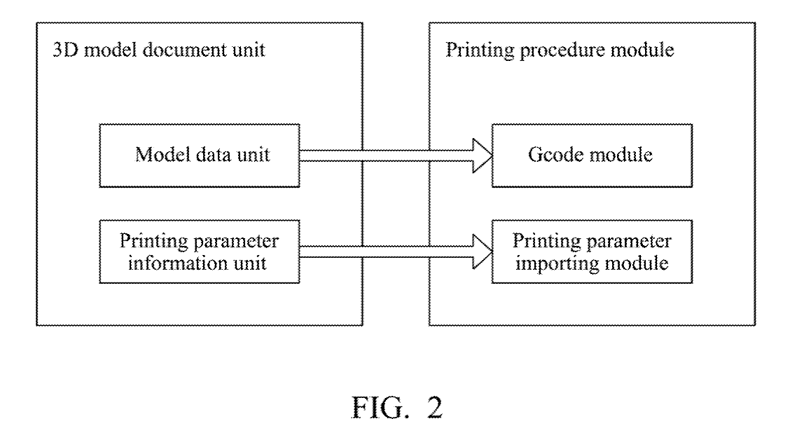

FIG. 2 is a schematic diagram illustrating a process of importing the 3D model document into the printing procedure according to an embodiment of the invention. A 3D model document unit includes a model data unit and a printing parameter information unit. The model data unit includes the model data information corresponding to the 3D printed object. The printing parameter information unit includes the printing parameter information corresponding to the 3D printed object. When the 3D printer prints, the printing parameter information unit imports the printing parameter information into a printing parameter importing module in a printing procedure module. The printing parameter importing module transmits the printing parameter information to a Gcode module. The model data unit transmits the model data information corresponding to the 3D printed object to the Gcode module. The Gcode module encodes the printing parameter information and the model data information to obtain a graphical coding document at last.

In the process, if the printing parameter information is not all of the printing parameter information required in the 3D printing, the configured universal printing parameter information is further imported, and the universal printing parameter information corresponding to the printing parameter information is replaced by the printing parameter information as a set of printing parameter information to perform the 3D printing.

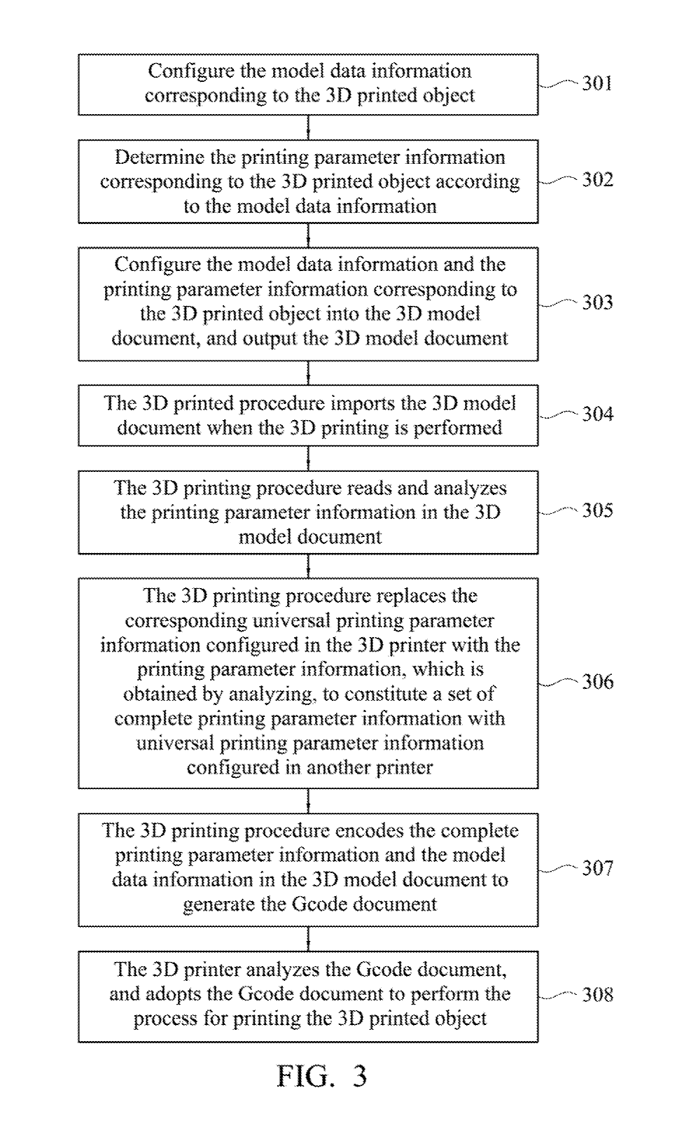

FIG. 3 is a flow chart of a printing method for the 3D printer ccording to an embodiment of the invention, and includes the following steps.

In a step 301 the model data information corresponding to the 3D printed object is configured.

In a step 302, the printing parameter information corresponding to the 3D printed object is determined according to the model data information. In this step, a 3D printing uniqueness of the 3D printed object is determined according to the model data information so as to determine required specific printing parameter information and obtain the final printing parameter information corresponding to the 3D printed object.

In a step 303, the model data information and the printing parameter information corresponding to the 3D printed object are configured into the 3D model document, and the 3D model document is outputted.

In a step 304, the 3D printing procedure imports the 3D model document when the 3D printing is performed,

In a step 305, the 3D printing procedure reads in and analyzes the printing parameter information in the 3D model document.

In a step 306, the 3D printing procedure replaces the corresponding universal printing parameter information configured in the 3D printer with the printing parameter information which is obtained by analyzing, to constitute a set of complete printing parameter information with universal printing parameter information configured in another printer.

In a step 307, the 3D printing procedure encodes the complete printing parameter information and the model data information in the 3D model document to generate the Gcode document.

In a step 308, the 3D printer analyzes the Gcode document, and adopts the Gcode document to perform the process for printing the 3D printed object.

A specific example that the 3D printed object is a cube model is provided below,

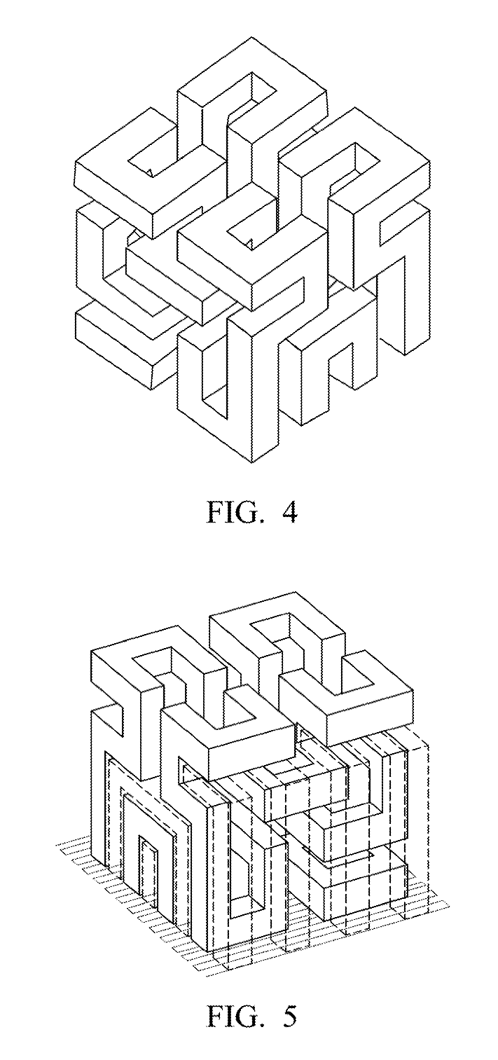

As shown in FIG. 4, the 3D printed object to be printed is a cube. Because the structure of the cube has many interspaces, the specific printing parameter information is required during the 3D printing and a printing parameter <Everywhere> is required to completely print the cube.

First, the corresponding model data information and the corresponding printing parameter information are configured for the cube. The printing parameter information specific printing parameter information and includes the printing parameter <Everywhere> which is described specifically below.

<Parameter> //start a parameter configuration
<Support Material Choice>Everywhere</Support Material Choice>
// configure the printing parameter <everywhere>
</Parameter> //end of the parameter configuration

Then, the corresponding model data information and the printing parameter information configured for the cube are included into a 3D model document “cube.stl”, and the 3D model document is outputted.

Next, the 3D printing procedure imports the 3D model document “cube.stl”, and reads in a section of <Parameter> in the printing parameter information. The 3D printing procedure analyzes and obtains the printing parameter <Everywhere>, and replaces a configured default printing parameter <Exterior Only> with the printing parameter <Everywhere>. The 3D printing procedure combines the printing parameter <Everywhere> with other universal printing parameter information to constitute the complete printing parameter information.

Afterwards, the 3D printing procedure performs a 3D printer encoding on the model data information in the 3D model document “cube.stl” and on the constituted complete printing parameter information to generate the Gcode document.

Thereafter, the 3D printer analyzes the Gcode document and starts the 3D printing to obtain the cube.

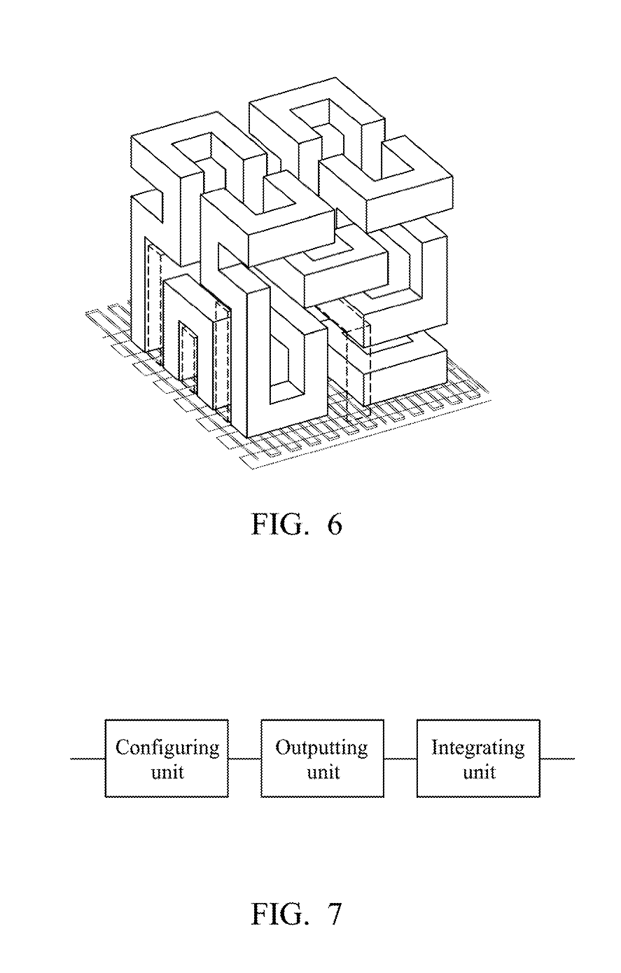

Referring to FIG. 5, an area with dashed lines in FIG. 5 is a fully supporting structure generated according to the printing parameter“<Support Material Choice>Everywhere”, thereby ensuring the printed cube not to collapse. (for simplicity, not all of the supporting structures are illustrated). As such, even when the structure of the cube is special, the structure of the printed cube is guaranteed to be complete because the specific printing parameter information is configured according to the special structure and is applied to the process of the 3D printing. If the default printing parameter configured in accordance with the prior art is directly adopted to perform the 3D printing, then the generated printing result is as shown in FIG. 6, in which many portions of the cube do not have supporting structures, especially in an upper portion of the cube. During the process of the practical 3D printing, this type of the cubic model does not have the possibility to be printed and formed, and will generally collapse during the printing process.

FIG. 7 is a schematic diagram illustrating a storage device of the 3D printer according to an embodiment of the invention. The storage device includes a configuring unit, an outputting unit and an integrating unit. The configuring unit is adapted to configure the model data information and the printing parameter information corresponding to the 3D printed object. The outputting unit is adapted to include the configured model data information and the printing parameter information into a 3D model document and output the 3D model document. The integrating unit is adapted to obtain the corresponding model data information and the printing parameter information from the 3D model document and encode it to obtain a Gcode document.

In the device, the integrating unit is further adapted to perform a encoding procedure to generate the Gcode document after replacing universal printing parameter information configured in the 3D printer with the printing parameter information obtained from the 3D model document to constitute complete printing parameter information with universal printing parameter information configured in another printer, or after adding the printing parameter information obtained from the 3D model document into an end of the universal printing parameter information configured in the 3D printer and adopting an universal format to output the universal printing parameter information.

In the device, the printing parameter information is specific printing parameter information regarding a feature of t he 3D printed object. The integrating unit is further adapted to obtain universal printing parameter information configured in the 3D printer, adopt the specific printing parameter information corresponding to the feature of the 3D printed object, and exclude universal printing parameter information except the specific printing parameter information corresponding to the feature of the 3D printed object, and perform an encoding procedure to obtain the Gcode document.

In the device, the printing parameter information includes the specific printing parameter information regarding the feature of the 3D printed object and the universal printing parameter information of the 3D printer.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A printing method of a three-dimensional (3D) printer, the printing method comprising:
configuring model data information and printing parameter information corresponding to a 3D printed object, wherein the model data information and the printing parameter information are included in a same printing software of the 3D printed object;
obtaining the model data information and the printing parameter information corresponding to the 3D printed object when the 3D printer prints the 3D printed object; and
adopting the corresponding printing parameter information, and performing a process for printing the 3D printed object according to the model data information of the 3D printed object.

2. The printing method of claim 1, wherein the printing parameter information is specific printing parameter information regarding, a feature of the 3D printed object;
the step of adopting the corresponding printing parameter information and performing a process for printing the 3D printed object according to the model data information of the 3D printed object comprises:
obtaining universal printing parameter information configured in the 3D printer; and
adopting the specific printing parameter information regarding the feature of the 3D printed object, excluding the universal printing parameter information except the specific printing parameter information regarding the feature of the 3D printed object, and performing the process for printing the 3D printed object according to the model data information of the 3D printed object.

3. The printing method of claim 1, wherein the printing parameter information comprises specific printing parameter information regarding a feature of the 3D printed object, and universal printing parameter information of the 3D printer.

4. The printing method of claim 1, wherein before the step of obtaining the model data information and the printing parameter information corresponding to the 3D printed object, the printing method comprises:
including the model data information and the printing parameter information corresponding to the 3D printed object into a 3D model document, and outputting the 3D model document;
the step of obtaining the printing parameter information corresponding to the 3D printed object comprises:
configuring a 3D printing procedure to import the 3D model document, replacing universal printing parameter information configured in the 3D printer with the printing parameter information in the 3D model document to constitute complete printing parameter information with universal printing parameter information configured in another printer, and adopting an universal format to output the complete printing parameter information.

5. The printing method of claim 1, wherein before the step of obtaining the model data information and the printing parameter information corresponding to the 3D printed object, the printing method comprises:
including the model data information and the printing parameter information corresponding to the 3D printed object into a 3D model document, and outputting the 3D model document;
the step of obtaining the printing parameter information corresponding to the 3D printed object comprises:
configuring a 3D printing procedure to import the 3D model document, adding the printing parameter information in the 3D model document into an end of universal printing parameter information configured in the 3D printer, and adopting a universal format to output the universal printing parameter information.

6. The printing method of claim 4, wherein the step of adopting the corresponding printing parameter information, and performing the process for the printing the 3D printed object according to the model data information of the 3D printed object comprises:
encoding, by the 3D printing procedure, the complete printing parameter information and the model data information in the 3D model document to generate a graphical coding document; and
analyzing, by the 3D printer, the graphical coding document, and using the graphical coding document to perform the process for printing the 3D printed object.

7. A storage device of a 3D printer, the storage device comprising:
a configuring unit adapted to configure model data information and printing parameter information corresponding to a 3D printed object, wherein the model data information and the printing parameter information are included in a same printing software of the 3D printed object;
an outputting unit adapted to output the model data information and the printing parameter information; and
an integrating unit adapted to encode the model data information and the printing parameter information obtained from the outputting unit to generate a graphical coding document.

8. The storage device of claim 7, wherein the outputting unit is further adapted to include the model data information and the printing parameter information into a 3D model document, and to output the 3D model document;
the integrating unit is further adapted to perform a encoding procedure to generate the graphical coding document after replacing universal printing parameter it formation configured in the 3D printer with the printing parameter information obtained from the 3D model document to constitute complete printing parameter information with universal printing parameter information configured in another printer, or after adding the printing parameter information obtained from the 3D model document into an end of the universal printing parameter information configured in the 3D printer.

9. The storage device of claim 7, wherein the printing parameter information is specific printing parameter information regarding a feature of the 3D printed object;
the integrating unit is further adapted to obtain universal printing parameter information configured in the 3D printer, adopt the specific printing parameter information corresponding to the feature of the 3D printed object, and exclude universal printing parameter information except the specific printing parameter information corresponding to the feature of the 3D printed object, and perform an encoding procedure to generate the graphical coding document.

10. The storage device of claim 7, wherein the printing parameter information comprises specific printing parameter information regarding a feature of the 3D printed object, and universal printing parameter information of the 3D printer.
